(19) United States
(12) Patent Application Publication
(10) Pub. No.: US 2025/0341115 A1
(43) Pub. Date: Nov. 6, 2025

(54) Door Latch System

(71) Applicant: Willo Products Company, LLC, Decatur, AL (US)

(72) Inventors: Brian S. Foss, Madison, AL (US); Ben Munson, Hartselle, AL (US)

(21) Appl. No.: 19/193,115

(22) Filed: Apr. 29, 2025

Related U.S. Application Data
(60) Provisional application No. 63/640,912, filed on May 1, 2024.

(51) Int. Cl. E05B 17/20; E05B 65/00; E05C 1/02

(52) U.S. Cl. CPC E05B 17/2084; E05C 1/02; E05B 65/0017

(57) ABSTRACT

A lock system includes a first housing and a lock bolt. The first housing includes a recessed area and a first opening disposed within the recessed area. The lock bolt is supported by the first housing and configured to move between a first position and a second position. The lock bolt extends beyond the recessed area in the first position. The lock bolt is disposed within the recessed area in the second position. The lock bolt blocks the first opening in the first position and the second position.

### CROSS-REFERENCE TO RELATED APPLICATION

This application claims the benefit of U.S. Provisional Application No. 63/640,912 filed May 1, 2024, the entire disclosure of which is incorporated by reference.

### FIELD

The present disclosure relates to a tamper-resistant locking system for a door and, more particularly, to a locking system including an extended lock bolt and a floating shim for blocking an opening formed in a door or a door frame.

### BACKGROUND

Door locking systems are essential components for securing doors at prisons and various other properties and facilities. These systems are typically attached to the exterior side of a door, allowing authorized individuals to access a room (e.g., a prison cell) on the interior side of the door, and preventing unauthorized individuals from opening the door and exiting the room on the interior side of the door. The security of these door locking systems can be compromised if the housing enclosing the locking system is susceptible to tampering or forced entry. For example, tampering with the door locking system or components thereof can prevent an aperture or opening formed in one of the door or a frame in which the door is received from receiving a lock bolt disposed on the other of the door or the frame, or prevent the lock bolt from extending into the aperture or opening formed in one of the door or the frame, which, in turn, can prevent the door from being secured in a closed position relative to the frame.

While known systems and methods for securing door locking systems may be acceptable for their intended purposes, there exists a continuous need in the pertinent art for an improved system and method for inhibiting tampering with a door locking system.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a lock system. The lock system includes a first housing and a lock bolt. The first housing includes a recessed area and a first opening disposed within the recessed area. The lock bolt is supported by the first housing and configured to move between a first position and a second position. The lock bolt extends beyond the recessed area in the first position. The lock bolt is disposed within the recessed area in the second position. The lock bolt blocks the first opening in the first position and the second position.

Another aspect of the disclosure provides a lock system. The lock system includes a lock bolt and a shim. The lock bolt is supported by a first housing and is configured to move between a first position and a second position. The first housing includes a recessed area and a first opening disposed within the recessed area. The lock bolt at least partially blocks the first opening in the first position and the second position. The shim defines an aperture. The shim surrounds the lock bolt and is supported by the first housing. The shim at least partially blocks the first opening.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a first perspective view of a door locking system in a first orientation according to the principles of the present disclosure.

FIG. 1B is a second perspective view of a first housing assembly of the door locking system of FIG. 1A according to the principles of the present disclosure.

FIG. 1C is a third perspective view of the door locking system of FIG. 1A in a second orientation according to the principles of the present disclosure.

FIG. 2A is a top plan view of the door locking system of FIG. 1A in a first orientation according to the principles of the present disclosure.

FIG. 2B is a top plan view of the door locking system of FIG. 1A in a second orientation according to the principles of the present disclosure.

FIG. 3A is a front view of the door locking system of FIG. 1A in the first orientation according to the principles of the present disclosure.

FIG. 3B is a front view of the door locking system of FIG. 1A in the second orientation according to the principles of the present disclosure.

In the drawings, reference numbers may be reused to identify similar and/or identical elements.

### DETAILED DESCRIPTION

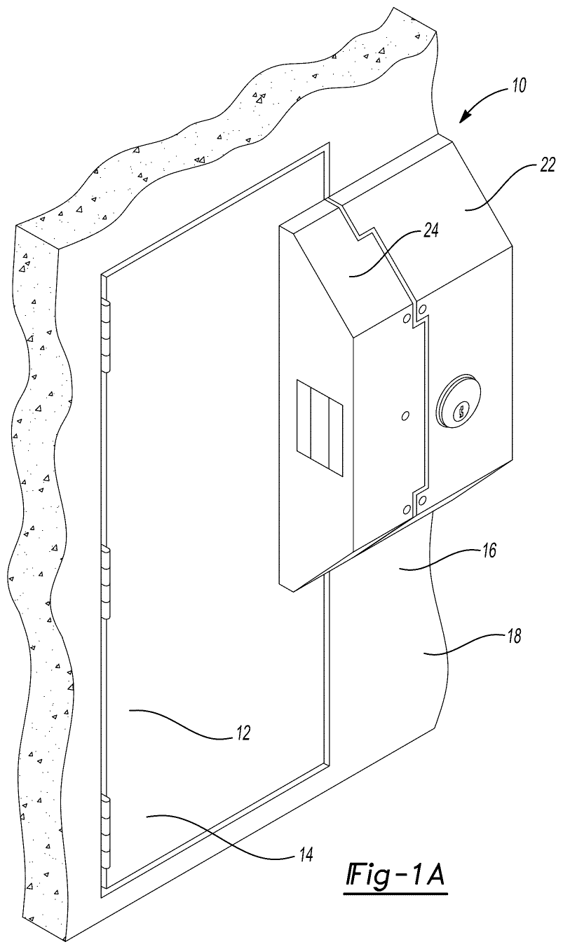

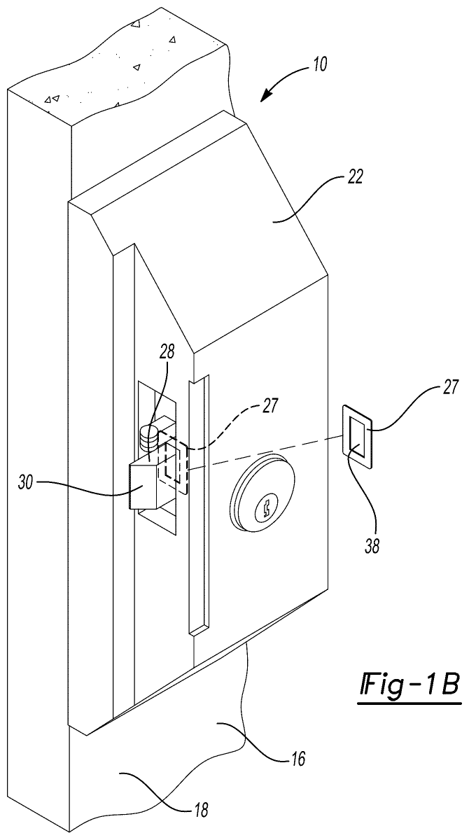

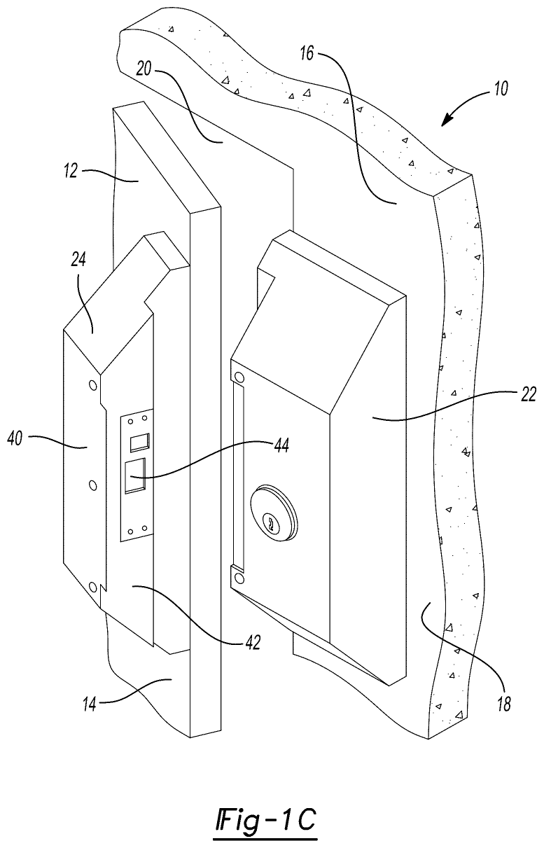

Referring to FIGS. 1A-1C, a lock system 10 is illustrated. As will be explained in more detail below, the lock system 10 may be mounted on an exterior surface 12 of a door 14 and an exterior surface 16 of a wall 18 to secure the door 14 in a closed orientation (FIG. 1A) relative to the wall 18. The door 14 may pivot (e.g., clockwise) relative to the wall 18 from an open orientation (FIG. 1C) to the closed orientation (FIG. 1A) to inhibit passage through an opening 20 defined by the door 14 and the wall 18. Conversely, the door 14 may pivot relative to the wall 18 from the closed orientation (FIG. 1A) to the open orientation (FIG. 1C) to allow passage through the opening 20.

The lock system 10 may include a first housing assembly 22 and a second housing assembly 24. While the first housing assembly 22 is generally shown and described herein as being mounted on the wall 18, and the second housing assembly 24 is generally shown and described herein as being mounted on the door 14, it will be appreciated that the first housing assembly 22 may be mounted on the door 14, and the second housing assembly 24 may be mounted on the wall 18 within the scope of the present disclosure. In some implementations, the first housing assembly 22 may be the door 14 or the wall 18 or be mounted within the door 14 or the wall 18, and the second housing assembly 24 may be the other of the door 14 or the wall 18 or be mounted within the other of the door 14 or the wall 18. In this regard, the door 14 may be the first housing assembly 22 or the second housing assembly 24, and the wall 18 may be the first housing assembly 22 or the second housing assembly 24.

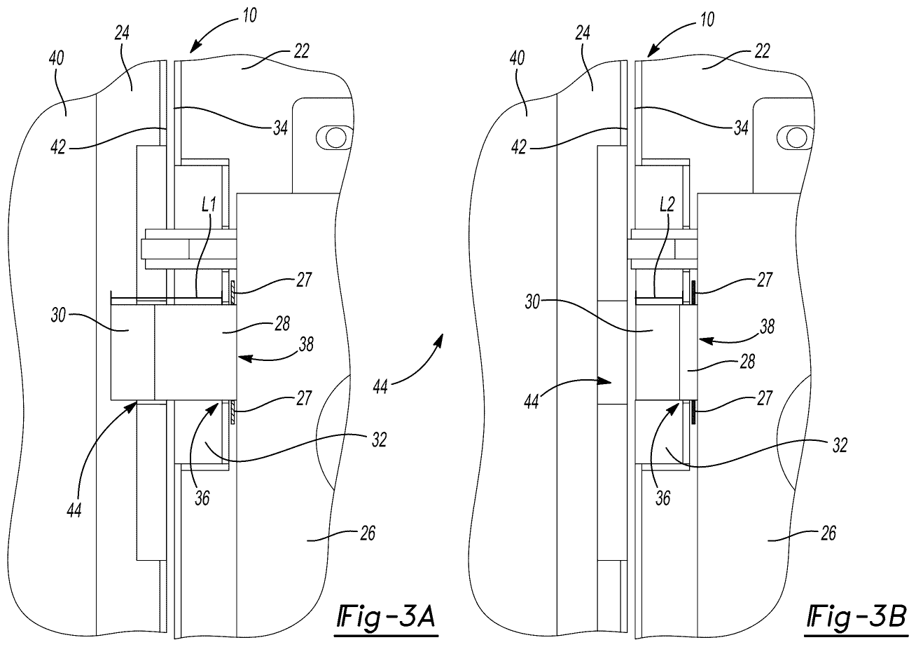

Referring now to FIGS. 1B and 2A-3B, the first housing assembly 22 may include a first housing 26, a shim 27, and a lock bolt 28. The lock bolt 28 may be disposed within the first housing 26.

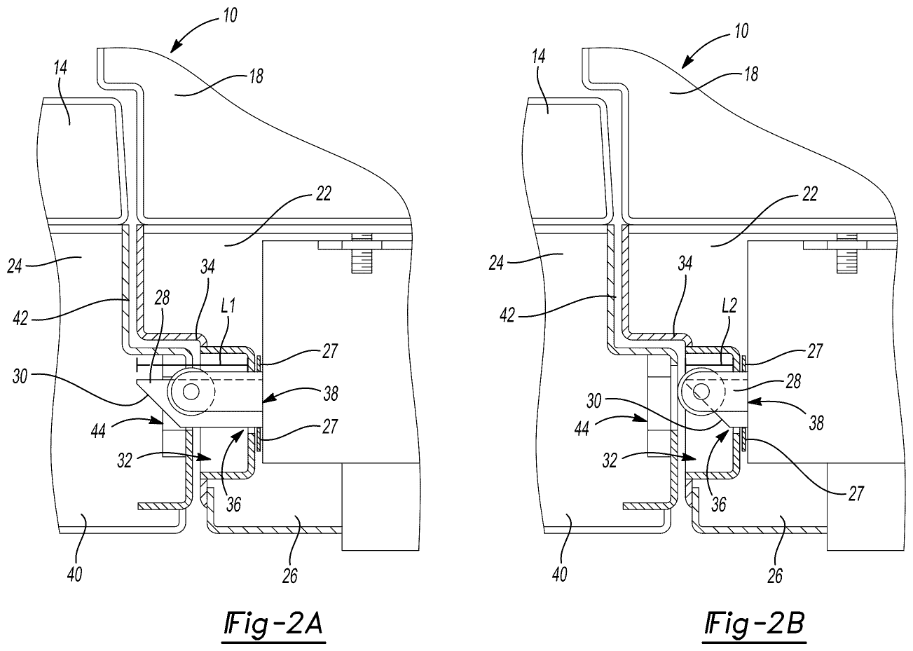

The lock bolt 28 may be coupled to (e.g., supported by) the first housing 26 and include a first end 30. In some implementations, the first end 30 of the lock bolt 28 is a tapered end. As will be explained in more detail below, during operation of the lock system 10, the lock bolt 28 may be configured to move between an extended position (FIG. 2A) and a retracted position (FIG. 2B). In the extended position (FIG. 2A), the lock bolt 28 may extend outside of the first housing 26 at a first length L1. In the retracted position (FIG. 2B), the lock bolt 28 may extend outside of the first housing 26 at a second length L2. In some implementations, the second length L2 is shorter than the first length L1.

The first housing 26 may define a recessed area 32 disposed on a first side 34 of the first housing 26. When the door 14 is in the closed orientation (FIG. 1A), the first side 34 of the first housing 26 may face the second housing assembly 24. The first housing 26 may also define an opening 36 disposed on the first side 34 of the first housing 26. The opening 36 may be disposed within the recessed area 32. The opening 36 may receive the lock bolt 28. In this regard, the opening 36 may be substantially the same shape and/or size as at least a portion of the lock bolt 28. In some implementations, the opening 36 may be a rectangle. The opening 36 may be slightly larger than the lock bolt 28 to allow the lock bolt 28 to move (e.g., translate) freely through the opening 36. In some implementations, the opening 36 may be sized such that there is a zero or near zero clearance between the lock bolt 28 and the opening 36.

As will be explained in more detail below, during operation of the lock system 10, the lock bolt 28 may be configured to move between the extended position (FIG. 2A) and the retracted position (FIG. 2B). In the extended position (FIG. 2A), the lock bolt 28 may extend outside of the first housing 26 and extend outside of the recessed area 32. In the retracted position (FIG. 2B), the lock bolt 28 (e.g., the first end 30) may extend outside of the first housing 26, but may not extend outside of the recessed area 32. For example, the first end 30, including an entirety of the tapered portion (e.g., the first end 30), may be disposed entirely within the recessed area 32 and protrude from the opening 36.

The shim 27 may be disposed within the first housing 26. In some implementations, the shim 27 is disposed directly behind the opening 36 of the first housing 26. The shim 27 may, at least partially, block the opening 36 of the first housing 26. The shim 27 may receive the lock bolt 28. For example, the shim 27 may define an aperture 38 that receives the lock bolt 28. In some implementations, the shim 27 surrounds the lock bolt 28. For example, the lock bolt 28 and the aperture 38 may each have a substantially similarly-sized and shaped cross section (e.g., defining a rectangle). The lock bolt 28 may be disposed within the aperture 38. In implementations where the opening 36 is larger than the lock bolt 28, the shim 27 may block any open space between the opening 36 and the lock bolt 28. The lock bolt 28 and/or the shim 27 may completely block the opening 36.

The second housing assembly 24 may include a second housing 40 defining a first side 42 and an opening 44. In some configurations, the opening 44 is disposed on the first side 42. When the door 14 is in the closed orientation (FIG. 1A), the first side 42 of the second housing 40 may face the first housing assembly 22. The opening 44 may be configured to receive the lock bolt 28. For example, when the door 14 is in the closed orientation (FIG. 1A), the lock bolt 28 may be disposed within the opening 44 of the second housing 40, and may secure the position of the first housing assembly 22 relative to the second housing assembly 24 when the door 14 is in the closed orientation (FIG. 1A). As the door 14 moves from the open orientation (FIG. 1C) to the closed orientation (FIG. 1A) the first side 42 of the second housing 40 may engage the lock bolt 28 (e.g., the first end 30 of the lock bolt 28). The recessed area 32 may allow the lock bolt 28 to be extended through the opening 36 of the first housing 26, but not the opening 44 of the second housing 40, while the first side 34 of the first housing 26 is in contact with the first side 42 of the second housing 40.

A first method of operating a lock system (e.g., the lock system 10) will now be described with reference to FIGS. 1A-3B. In a step of operating the lock system 10, the door 14 is moved from the open orientation (FIG. 1C) to the closed orientation (FIG. 1A). In the open orientation, the first housing assembly 22 is spaced apart from the second housing assembly 24, and the lock bolt 28 may extend outside the first housing 26. For example, the lock bolt 28 may extend beyond the first side 34.

As the door 14 moves from the open orientation to the closed orientation, the first housing assembly 22 may contact the second housing assembly 24. For example, the first side 42 of the second housing 40 may engage (e.g., translate across) the lock bolt 28 (e.g., the first end 30 of the lock bolt 28). As the first side 42 of the second housing 40 moves along the lock bolt 28 (e.g., the first end 30 of the lock bolt 28), the first side 42 of the second housing 40 may push the lock bolt 28 into the recessed area 32 of the first housing 26. When the lock system 10 reaches the closed orientation, the lock bolt 28 moves (e.g., translates) and extends past the recessed area 32 of the first housing 26 and into the opening 44 of the second housing 40.

A second method of operating a lock system (e.g., the lock system 10) will now be described with reference to FIGS. 1A-3B. In a step of operating the lock system 10, when the door 14 is in the open orientation (FIG. 1C), an individual may engage (e.g., push in) the lock bolt 28 (e.g., the first end 30 of the lock bolt 28). The lock bolt 28 may be pushed into the recessed area 32 of the first housing but not through the opening 36 of the first housing 26. The lock bolt 28 and/or the shim 27 may completely block the opening 36 of the first housing 26, even when the lock bolt 28 is pushed in.

The configuration and operation of the lock system 10 described herein can prevent an individual (e.g., an inmate) from forcing items (e.g., contraband) into the opening 36 of the first housing 26 when the door 14 is in the open orientation (FIG. 1C) and the lock bolt 28 is in the retracted orientation (FIG. 2B), thus ensuring that the lock bolt 28 can extend through the opening 36 of the first housing 26 and into the opening 44 of the second housing 40 enabling a secure locking of the door 14 when the lock system 10 is in the closed position (FIG. 1A).

The following Clauses provide an exemplary configuration for a lock system, as described above.

Clause 1: A lock system comprising: a first housing including a recessed area and a first opening disposed within the recessed area; and a lock bolt supported by the first housing and configured to move between a first position and a second position, wherein: the lock bolt extends beyond the recessed area in the first position, the lock bolt is disposed within the recessed area in the second position, and the lock bolt blocks the first opening in the first position and the second position.

Clause 2: The lock system of clause 1, further comprising a shim defining an aperture and at least partially blocking the first opening.

Clause 3: The lock system of clause 2, wherein the shim is disposed within the first housing.

Clause 4: The lock system of clause 3, wherein the shim surrounds the lock bolt.

Clause 5: The lock system of clause 4, wherein the lock bolt is disposed within the aperture of the shim.

Clause 6: The lock system of clause 5, wherein the lock bolt and the shim completely block the first opening.

Clause 7: The lock system of clause 6, further comprising a second housing including a second opening configured to receive the lock bolt.

Clause 8: The lock system of clause 7, wherein the lock bolt is disposed within the second opening when the lock bolt is in the first position.

Clause 9: The lock system of clause 8, wherein the second opening is aligned with the first opening.

Clause 10: The lock system of clause 9, wherein the second housing includes a first side, and the lock bolt is configured to engage the first side of the second housing.

Clause 11: The lock system of clause 10, wherein the second housing is operable to move the lock bolt from the first position to the second position when the first side engages the lock bolt.

Clause 12: A lock system comprising: a lock bolt supported by a first housing and configured to move between a first position and a second position, the first housing including a recessed area and a first opening disposed within the recessed area, the lock bolt at least partially blocking the first opening in the first position and the second position; and a shim defining an aperture, the shim surrounding the lock bolt and being supported by the first housing, the shim at least partially blocking the first opening.

Clause 13: The lock system of clause 12, wherein the lock bolt extends beyond the recessed area in the first position, and the lock bolt retracts into the recessed area in the second position.

Clause 14: The lock system of clauses 12 or 13, wherein the lock bolt is disposed within the aperture of the shim.

Clause 15: The lock system of any of clauses 12 through 14, wherein the lock bolt and the shim completely block the first opening.

Clause 16: The lock system of any of clauses 12 through 15, further comprising a second housing including a second opening configured to receive the lock bolt.

Clause 17: The lock system of clause 16, wherein the lock bolt is disposed within the second opening when the lock bolt is in the first position.

Clause 18: The lock system of clauses 16 or 17, wherein the second opening is aligned with the first opening.

Clause 19: The lock system of any of clauses 16 through 19, wherein the second housing includes a first side, and the lock bolt is configured to engage the first side of the second housing.

Clause 20: The lock system of clause 19, wherein the second housing is operable to move the lock bolt from the first position to the second position when the first side engages the lock bolt.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A lock system comprising:
a first housing including a recessed area and a first opening disposed within the recessed area; and
a lock bolt supported by the first housing and configured to move between a first position and a second position, wherein:
the lock bolt extends beyond the recessed area in the first position,
the lock bolt is disposed within the recessed area in the second position, and
the lock bolt blocks the first opening in the first position and the second position.

2. The lock system of claim 1, further comprising a shim defining an aperture and at least partially blocking the first opening.

3. The lock system of claim 2, wherein the shim is disposed within the first housing.

4. The lock system of claim 3, wherein the shim surrounds the lock bolt.

5. The lock system of claim 4, wherein the lock bolt is disposed within the aperture of the shim.

6. The lock system of claim 5, wherein the lock bolt and the shim completely block the first opening.

7. The lock system of claim 6, further comprising a second housing including a second opening configured to receive the lock bolt.

8. The lock system of claim 7, wherein the lock bolt is disposed within the second opening when the lock bolt is in the first position.

9. The lock system of claim 8, wherein the second opening is aligned with the first opening.

10. The lock system of claim 9, wherein the second housing includes a first side, and the lock bolt is configured to engage the first side of the second housing.

11. The lock system of claim 10, wherein the second housing is operable to move the lock bolt from the first position to the second position when the first side engages the lock bolt.

12. A lock system comprising:
a lock bolt supported by a first housing and configured to move between a first position and a second position, the first housing including a recessed area and a first opening disposed within the recessed area, the lock bolt at least partially blocking the first opening in the first position and the second position; and
a shim defining an aperture, the shim surrounding the lock bolt and being supported by the first housing, the shim at least partially blocking the first opening.

13. The lock system of claim 12, wherein the lock bolt extends beyond the recessed area in the first position, and the lock bolt retracts into the recessed area in the second position.

14. The lock system of claim 12, wherein the lock bolt is disposed within the aperture of the shim.

15. The lock system of claim 12, wherein the lock bolt and the shim completely block the first opening.

16. The lock system of claim 12, further comprising a second housing including a second opening configured to receive the lock bolt.

17. The lock system of claim 16, wherein the lock bolt is disposed within the second opening when the lock bolt is in the first position.

18. The lock system of claim 16, wherein the second opening is aligned with the first opening.

19. The lock system of claim 16, wherein the second housing includes a first side, and the lock bolt is configured to engage the first side of the second housing.

20. The lock system of claim 19, wherein the second housing is operable to move the lock bolt from the first position to the second position when the first side engages the lock bolt.
